(19) United States
(12) Patent Application Publication
(10) Pub. No.: US 2008/0079932 A1
(43) Pub. Date: Apr. 3, 2008

(54) Visual inspection apparatus and visual inspection method

(75) Inventor: Atsutoshi Yokota, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/906,072

(22) Filed: Sep. 28, 2007

(30) Foreign Application Priority Data
Sep. 29, 2006 (JP) P2006-268478

(51) Int. Cl. G01N 21/00

(52) U.S. Cl. 356/237.1

(57) ABSTRACT

The present invention is related to a visual inspection apparatus which can perform various adjustments simply and rapidly. The visual inspection apparatus includes a wafer holder for holding a wafer to be movable in the X, Y, and Z directions and rotatable about the Z axis and a peripheral edge imaging section used to observe a peripheral edge of the wafer W, which are disposed close to each other. A computer for controlling the visual inspection apparatus includes an inspection controller for performing a process of making a visual inspection of the peripheral edge of the wafer W pursuant to a recipe and an interrupt processor for stopping the inspection pursuant to the recipe and receiving a change in inspection condition from scroll bars when an inspector selects an interrupt process.

### CROSS-REFERENCE TO RELATED APPLICATIONS

This application claims priority from Japanese Patent Application No. 2006-268478, filed in the Japanese Patent Office on Sep. 29, 2006, the disclosure of which is incorporated herein by reference.

### BACKGROUND OF THE INVENTION

1. Field of the Invention

The present invention relates to an apparatus and a method of inspecting a visual of a substrate such as a wafer.

2. Description of Related Art

In semiconductor fabrication factories or the like, chips or defects occurring in the processes are inspected by observing a peripheral edge of a semiconductor wafer or the entire surface of the wafer including the peripheral edge. For example, an apparatus for automatically inspecting a peripheral edge of a wafer is disclosed in Japanese Unexamined Patent Publication No. 2003-243465. The inspection apparatus makes an inspection in a state where a wafer is placed on a rotating stage and an elastic member comes in contact with a peripheral end surface of the wafer to regulate the position of the wafer. In the vicinity of the peripheral edge of the wafer, a camera for photographing a top surface of the peripheral edge of the wafer, a camera for photographing a side surface of the peripheral edge, and a camera for photographing a bottom surface of the peripheral edge are disposed in the same plane. At the time of capturing an image of the peripheral edge, a notch position of the wafer is specified and then images are input from the cameras while rotating the wafer. The images of the cameras are processed by a photographed data processor and a defect extracting process is automatically performed except for the notch portions.

In general, the following requirements are known for such an apparatus. The thickness of the wafer or the polished shape of the peripheral edge may be different depending on the manufacturer of wafer or the like. Accordingly, when the kind or the fabrication lot of the wafer is changed in an inspection under a recipe, it is necessary to obtain a clear image of a portion to be inspected by adjusting the focuses of the cameras. When a zoom mechanism is mounted on the cameras, it is necessary to perform a zoom adjustment.

During the process, a micro warp, that is, a peripheral undulation in the peripheral edge may be generated in the wafer. Accordingly, every time an inspection position is changed in the peripheral edge of the wafer, it is necessary to perform the focus adjustment or the zoom adjustment.

An illuminating device used to photograph the peripheral edge may be adjusted due to the change in position in the peripheral edge, the uneven shape, chips, attachment of dust, and the like. When plural illuminating devices are used, it is necessary to perform the adjustment on the respective illuminating devices.

### SUMMARY OF THE INVENTION

According to an aspect of the invention for solving the above-mentioned problem, a visual inspection apparatus is provided for making a visual inspection of a peripheral edge of a wafer pursuant to a predetermined recipe. The visual inspection apparatus includes a wafer holder that holds a wafer so as to be rotatable and a peripheral edge imaging section that acquires an enlarged image of the peripheral edge of the wafer. The visual inspection apparatus further includes an interrupt processor that stops the visual inspection of the wafer pursuant to the predetermined recipe and performs an interrupt process in the course of making a visual inspection of the peripheral edge of the wafer pursuant to the predetermined recipe, an inspection condition setting section that can allow a change in inspection condition to be input for every inspection condition item as the interrupt process so as to perform an inspection under an inspection condition different from the predetermined recipe, and an input unit used to allow an inspector to input the inspection condition to the inspection condition setting section.

The visual inspection apparatus can make an inspection under a condition different from the recipe by performing an interrupt process in the course of making an inspection pursuant to the recipe. The inspection using the interrupt process may be made in one place or at a plurality of places.

### BRIEF DESCRIPTION OF THE DRAWINGS

FIG. 1 is a diagram illustrating a schematic configuration of a visual inspection apparatus according to an embodiment of the invention.

FIG. 2 is a diagram illustrating an arrangement example of cameras of a peripheral edge imaging section.

FIG. 3 is a diagram illustrating an example of a screen display for setting inspection conditions.

FIG. 4 is a flowchart illustrating processes of the visual inspection apparatus including an interrupt process.

FIG. 5 is a diagram illustrating a schematic configuration of the visual inspection apparatus having a jog dial.

FIG. 6 is a flowchart illustrating a procedure of registering a recipe at the time of performing the interrupt process.

### DETAILED DESCRIPTION OF THE INVENTION

### First Embodiment

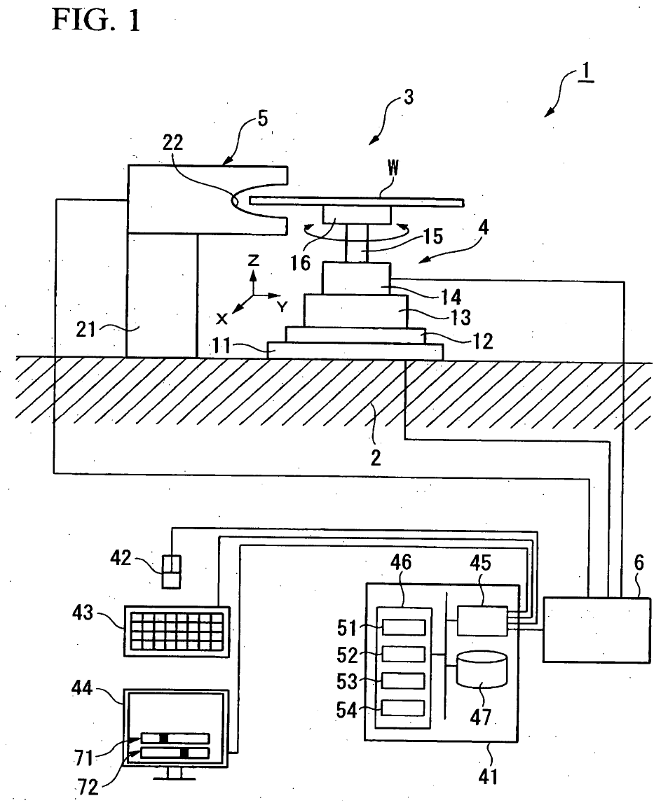

As shown in FIG. 1, a visual inspection apparatus 1 includes a base unit 2 fixed to a frame or the like (not shown) and an inspection unit 3 mounted on the base unit 2. The inspection unit 3 includes a wafer holder 4 on which a wafer W as an inspection target is placed and a peripheral edge imaging section 5 that is disposed close to the wafer holder 4 so as to acquire an image of a peripheral edge of the wafer W. The wafer holder 4 and the peripheral edge imaging section 5 are controlled by a apparatus control unit 6. A surface inspection section such as a microscope capable of observing the entire surface of the wafer W may be provided in addition to the peripheral edge imaging section 5.

The wafer holder 4 has an X stage 11 fixed to the base unit 2 so as to be movable in a horizontal direction indicated by X in FIG. 1. A Y stage 12 movable in a Y axis that is a horizontal direction perpendicular to the X axis is mounted on the X stage 11. A Z stage 13 movable in a Z direction that is a vertical direction perpendicular to the X and Y directions is mounted on the Y stage 12. Accordingly, the wafer holder 4 can move the wafer W three-dimensionally relative to the peripheral edge imaging section 5.

A rotating portion 14 is disposed in the Z stage 13. The rotating portion 14 has a rotation shaft 15 rotatable about the Z axis. The stages 11 to 13 and the rotation shaft 15 are driven by the use of a servo motor, a ball screw, or a deceleration mechanism. A stepping motor or a linear motor can be used as a driving source. A suction stage 16 is disposed at the top end of the rotation sh aft 15. An unshown suction portion for holding the wafer W by vacuum suction is disposed on the top surface of the suction stage 16.

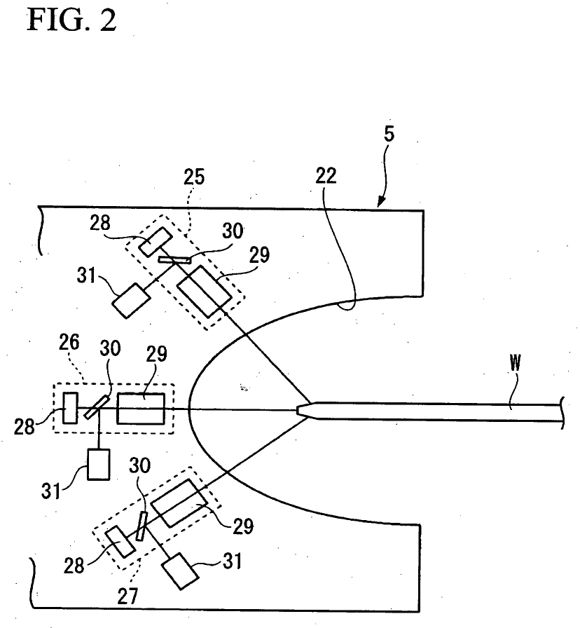

The peripheral edge imaging section 5 is supported by an arm 21 fixed to the base unit 2. The peripheral edge imaging section 5 has a substantially C shape having a concave portion 22 for receiving the peripheral edge of a wafer W in a side view and is provided with cameras for photographing the peripheral edge of the wafer W. An example of a trinocular type peripheral edge imaging section is shown in FIG. 2. The cameras include a first camera 25 for photographing a top surface of the peripheral edge of the wafer W, a second camera 26 for photographing a side surface of the peripheral edge of the wafer W, and a third camera 27 for photographing a bottom surface of the wafer W. Each of the cameras 25 to 27 has an imaging element 28 such as a charge coupled device (CCD) and a zoom lens 29 having a focus function and can constitute a concentric illumination system using an illuminating device 31 by disposing a half mirror 30 in the optical axis. The number of cameras may be changed 1, 5, or any number. When only one camera is used, a photographing position may be changed by movably supporting the camera or a photographing position of the fixed camera may be changed by the use of a movable mirror. The illuminating device 31 is not limited to the concentric illuminating system, but may be singularly or plurally disposed at a position away from the cameras 25 to 27. The illuminating device 31 preferably illuminates the peripheral edge so as to observe the peripheral edge in a bright view.

The apparatus control unit 6 shown in FIG. 1 controls the driving of the stages 11 to 13 and the rotating portion 14 of the wafer holder 4, controls the suction vacuuming, adjusts the zoom or focus of the cameras 25 to 27 of the peripheral edge imaging section 5, adjusts the light from the illuminating device 31, and receives image signals from the cameras 25 to 27. For example, the apparatus control unit includes a driver circuit for a motor, a driver circuit for controlling the opening and closing of a vacuuming valve, and the like. The apparatus control unit 6 is also connected to a computer 41.

The computer 41 is a general-purpose computer to which an input unit such as a mouse 42 or a keyboard 43 and a monitor 44 for displaying various settings or an image of the peripheral edge are connected. The mouse 42, the keyboard 43, and the monitor 44 are interfaces which can be operated by an inspector. The computer 41 has an I/O (Input/Output) unit 45 to which the apparatus control unit 6 or the mouse 42, the keyboard 43, and the monitor 44 are connected, a controller 46, and a memory 47 for storing data of recipes. The controller 46 includes a CPU (Central Processing Unit) and can be functionally divided into an inspection controller 51 for making an inspection pursuant to a recipe, an interrupt processor 52 for performing an interrupt process, a recipe register 53 for registering a recipe, and an image processor 54 for calculating the average brightness or the maximum brightness of an image or extracting defects. The computer 41 may be mounted on the visual inspection apparatus 1 or may be disposed separate from the apparatus. The computer 41 and the apparatus control unit 6 may form one control apparatus.

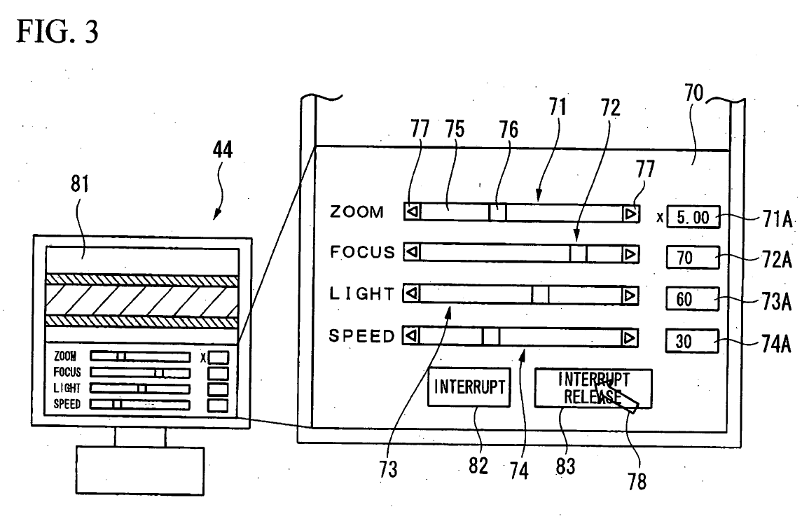

An example of a screen display in the monitor 44 is shown in FIG. 3. The picture on the screen serves as an inspection condition setting section used to set an inspection condition. In the function selecting picture 70 provided as the inspection condition setting section, a “ZOOM” scroll bar 71 for adjusting the zoom of the cameras 25 to 27 on the picture, a “FOCUS” scroll bar 72 for adjusting the focus of the cameras 25 to 27, a “LIGHT” scroll bar 73 used for light adjustment, and a “SPEED” scroll bar 74 for adjusting the rotation speed of the wafer W are arranged and displayed. The scroll bars 71 to 74 have a horizontally thin and longitudinal scroll box 75, a scroll thumb 76 indicating the current scroll position is disposed in the scroll box 75, and scroll arrows 77 are disposed at both ends of the scroll box 75. The scroll arrow 77 can be clicked by the use of a pointer 78 of the mouse 42. The scroll thumb 76 can be dragged and moved by the use of the mouse 42 and can be also moved by the use of a cursor key of the keyboard 43.

In the vicinity of the scroll bars 71 to 74, display columns 71A to 74A for set values corresponding to the current scroll position are provided at every inspection condition item. For example, the set value “×5.00” displayed associated with the “ZOOM” scroll bar 71 means that 5 times is selected as a zoom magnification. By inputting a numerical value through the keyboard 43 in a state where the display columns 71A to 74A are clicked by the use of the mouse 42 and are activated, it is possible to set the inspection condition. In this case, the scroll thumbs 76 are shifted depending on the input numerical values.

Although not shown, a scroll bar for inputting conditions for the X, Y, and Z directions or a scroll bar for setting a peripheral position of the wafer W may be disposed in the function selecting screen provided as the inspection condition setting section so as to set the position of the wafer W. The scroll bars may be disposed on the function selecting screen 70 or on another function selecting screen that can be displayed instead of the function selecting screen 70.

Next, operations of this embodiment will be described.

A wafer W transported by a robotic arm or the like is aligned by the use of an alignment device not shown and is placed on the suction stage 16 so as to match the center of the wafer W with the rotation center thereof. The apparatus control unit 6 allows the suction portion to suction the vicinity of the center on the rear surface of the wafer W by vacuum.

The peripheral edge of the wafer W positioned and held by the wafer holder 4 is inspected pursuant to a recipe registered in advance. The computer 41 reads out the recipe selected by the inspector from the memory 47 and allows the inspection controller 51 to execute the read-out recipe. The recipe is to define various conditions such as the zoom, the focus, and illuminating devices of the cameras 25 to 27 and the rotations speed of the wafer W. The apparatus control unit 6 outputs an instruction signal to the X stage 11 or the like pursuant to the recipe. The scroll bars 71 to 74 shown in FIG. 3 may be used to set the recipe. The computer 41 sequentially records the changes of the scroll bars 71 to 74 every inspection position to prepare a recipe for inspecting one sheet of wafer W and the recipe register 53 then registers the prepared recipe in the memory 47.

At the time of making an inspection pursuant to the recipe, the mouse 42 or the like is operated to read out and execute a desired recipe. The wafer W rotates at a predetermined speed and the cameras 25 to 27 acquire images of the peripheral edge and display the acquired images on the monitor 44. Since the X, Y, and Z coordinates of the wafer holder 4 are adjusted so as to display the images of the peripheral edge at the substantial center of the monitor 44, the inspector checks the monitor 44 with his naked eyes to inspect whether defects such as chips exist. The inspection is performed at a plurality of places or a plurality of areas with a predetermined distance in the peripheral direction, but may be performed continuously in the peripheral direction.

A defect may be automatically extracted and the inspection result may be registered in the memory 47, by performing an image process of inputting and storing a reference picture in advance, calculating a difference between the stored reference image and the currently observing image, and considering the wafer as being defective when the calculated difference is greater than a predetermined threshold value. The image processor 54 may calculate the average brightness or the maximum brightness of an image signal from the imaging element 28 and then may automatically perform the interrupt process when the calculated value is greater than a predetermined threshold value.

When the defect at an expected inspection position could be inspected, the rotation of the wafer W is stopped, the suction is released, and then the wafer W is unloaded by the use of the robotic arm.

On the contrary, when the wafer W is warped, the peripheral edge of the wafer W may depart from the focus of the cameras 25 to 27. The light intensity of the illuminating device 31 may not be sufficient so as not to be a sufficient brightness or to be too bright. In this case, the visual inspection cannot be made so long as the inspection condition is not changed.

A defect is distinguishably displayed, but the defect may be displayed at an end of the monitor 44 or depending on the inspector's condition, the inspector may feel the rotation speed is too fast. When a different inspector replaces the current inspector, it may be necessary to adjust the rotation speed depending on the inspector's degree of expertise. In this case, inspection is possible but it is preferable that the inspection condition is changed.

In the above-mentioned cases, the inspector pushes an interrupt button to change the inspection condition during the inspection. The interrupt button may be provided as a GUI (Graphical User Interface) on the monitor 44 of the computer 41 so as to be operated by the use of the mouse 42, or may be provided in hardware on an operation panel not shown. An example of the interrupt button disposed on the monitor 44 as the GUI and a button for releasing the interrupt process is shown in the lower portion of FIG. 3. An image 81 of the peripheral edge under the inspection is displayed on substantially the entire surface of the monitor 44 and an interrupt button 82 and an interrupt release button 83 are disposed in parallel below it.

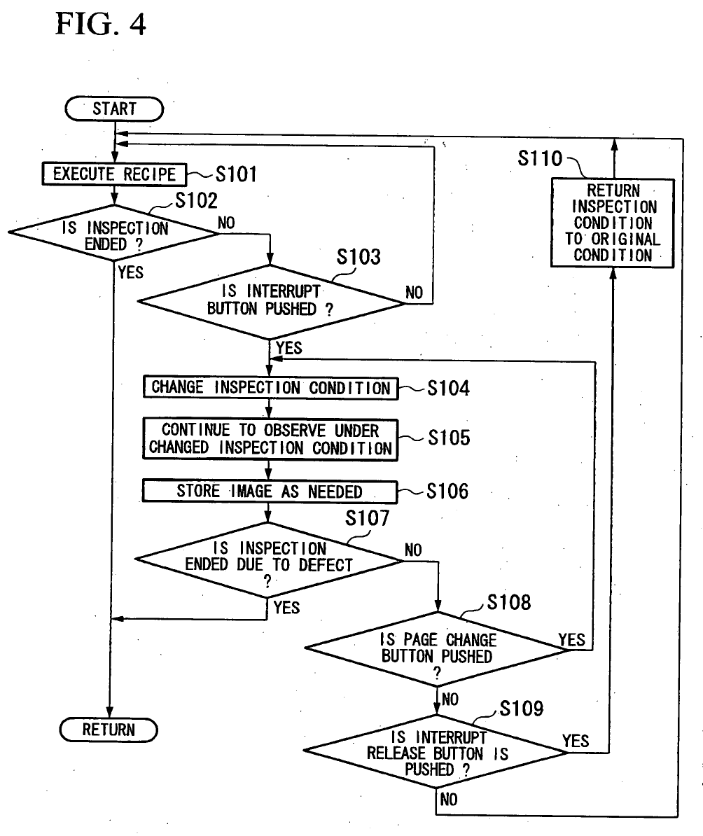

A flowchart illustrating the interrupt process is shown in FIG. 4. A previously registered recipe is performed in step S101. When an inspector pushes the interrupt button 82 (Yes in step S103) before the inspection is ended (No in step S102), the interrupt processor 52 can change the settings on the inspection condition setting section, that is, the function selecting screen 70, with reference to the image 81 of the peripheral edge of the monitor 44. Accordingly, the scroll bars 71 to 73 are operated by the use of the mouse 42 to change the inspection condition (step S104). For example, when the focus is not correct due to the deformation of the wafer W or the like, the “FOCUS” scroll bar 72 is operated to change the focus. When the position of the wafer W is deviated from the peripheral edge imaging section 5, the peripheral edge is displayed at an end of the image 81. Accordingly, in order to shift the peripheral edge to the center of the image 81, the X, Y, and Z coordinates of the wafer holder 4 are adjusted by displaying scroll bars (not shown) for setting the X, Y, and Z coordinates. Any inspection condition is predetermined in its settable range and thus the inspection conditions can be changed within the settable ranges. When it is intended to select an inspection condition outside the settable range, an interlock is operated and thus such an input is invalid.

Then, the observation is continuously performed while the inspection condition is changed (step S105). When the interrupt button is pressed, the interrupt processor 52 may control the rotation speed of the wafer holder 4 to be equal to or less than a predetermined value until the interrupt release button is pressed. Since the cameras 25 to 27 are focused on the peripheral edge, the images displayed on the monitor 44 are checked with the naked eyes to determine whether a defect exists in the peripheral edge of the wafer W. The images are stored by pushing a storage button not shown as needed (step S106). The images are stored, for example, when a defective state needs to be stored as data or the processes are intended to be improved by the use of the image. For example, when a chip or the like stopping the process is discovered, the inspection is ended in this step by pushing an end button not shown (Yes in step S107).

When no defect is found or when the process can be subsequently performed in spite of a defect (No in step S107), the process of step S108 is performed. When an inspection condition not shown in the current function selecting screen 70 needs to be changed additionally, the process returns to step S104 is performed again by pushing a page change button not shown (Yes in step S108). An example of such a case can includes a case where a photographing angle needs to be further adjusted and a case where another inspection condition such as lighting another illuminating device needs to be changed.

On the contrary, when no more changes in the inspection condition are required (No in step S108), the interrupt processor 52 determines whether or not the interrupt release button 83 is pressed (step S109). When the interrupt release button 83 is pressed, the interrupt processor 52 releases the interrupt process (step S110) and restores the inspection condition to the set value of the recipe and then the inspection controller 51 resumes the inspection pursuant to the normal recipe in step S101. At this time, the inspection is resumed from the inspection position or the inspection condition at the time of starting the interrupt process.

When it is determined in step S109 that the interrupt release button is not pressed, the inspection is successively performed under the changed inspection condition in step S101 again.

When a recipe registration button 93 displayed on the monitor 44 of FIG. 1 is pressed after the inspection condition is changed, the recipe register 53 registers the recipe and the existing recipe is overwritten by the condition changed in step S104. The recipe may be registered as a new recipe different from the existing recipe. The recipe registration button 93 may be provided in hardware.

According to the above-mentioned condition, since the interrupt process can be performed in the course of making an inspection pursuant to the recipe, it is possible to perform an inspection under a condition different from the recipe depending on an individual difference between wafers or an inspector's conditions. It is possible to conduct an inspection with high precision even when individual differences exist between wafers. Since the condition can be changed during the inspection, it is possible to easily perform the adjustment. In addition, since it is not necessary to resume the inspection from the beginning, it is possible to reduce the tact time for the inspection.

In this embodiment, when the peripheral edge is being inspected pursuant to a recipe prepared in advance, the interrupt process of changing the inspection condition for observation can be performed without changing a basic recipe operation. Accordingly, even when it is difficult to make an accurate inspection due to individual differences between the wafers W, it is possible to make an inspection while adjusting the differences. It is also possible to make an inspection without completely stopping the visual inspection apparatus 1, and it is not necessary to prepare recipes every time it is required even when necessary, thereby facilitating the processes. Since the interrupt process can be performed when it is necessary to change the inspection condition, the desired place can be inspected successively after changing the condition. In the configuration of the prior art, when a recipe is changed, the inspection must again be made from the first state. However, in this embodiment of the present invention, it is possible to change the inspection condition only at a necessary position. This advantage is true even when the inspector is replaced by a different inspector or when the inspection condition is changed in consideration of an inspector's degree of fatigue.

In order to change the inspection condition, the scroll bars 71 to 74 displayed as the inspection condition setting section can be operated, thereby facilitating the operation. In addition, since it can be recognized with the naked eye which condition in the adjustable range is used at the position of the scroll thumb 76, such situations can be easily recognized as images. Since specific set values are displayed on the display columns 71A to 74A in association with set items, it is possible to easily check the change in inspection condition. Since a new recipe is registered by the change in condition, it is possible to make subsequent inspection using the new recipe.

When the magnification of a camera is enhanced, the observation can be easily made at a low rotation speed. Accordingly, a correlation between the magnifications of the cameras 25 to 27 and the rotation speeds enabling easy observation at the magnifications may be stored in advance in the computer 41 and the rotation speed of the wafer W may be automatically changed when the image is enlarged with a zoom. In this way, when plural inspection conditions are adjusted in correlation, the setting items to be adjusted are not limited to the magnification and the rotation speed.

### Second Embodiment

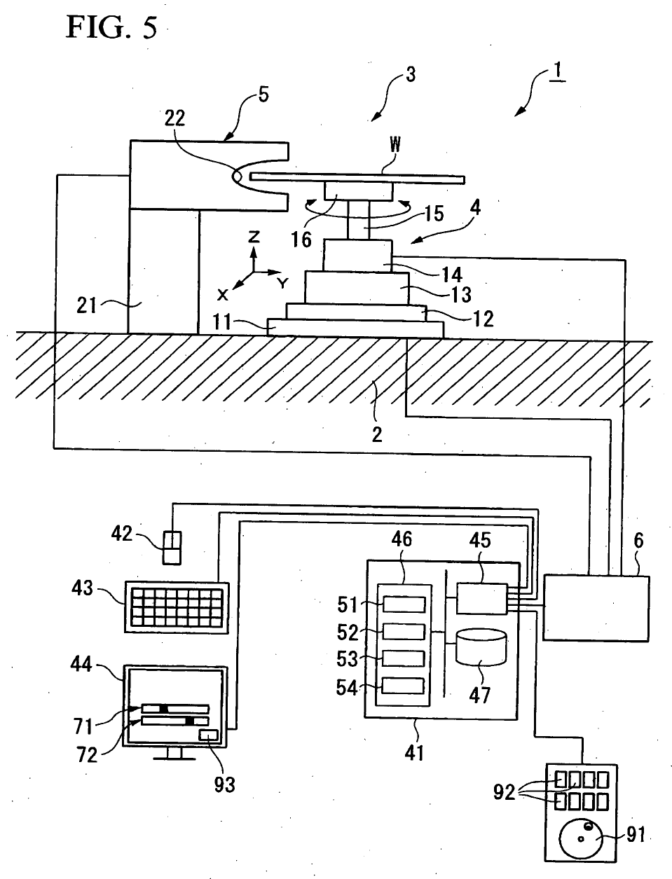

A second embodiment of the invention is characterized in a different interrupt process. The visual inspection apparatus 1 shown in FIG. 5 has the same configuration as the first embodiment, except that a jog dial 91 is added as an input unit.

The jog dial 91 is a data input interface and is rotated with one's finger for use. The setting items can be adjusted by the use of the rotation direction and the rotation speed of the jog dial 91. As for a zoom function, for example, a variation in magnification is small when the jog dial 91 is made to rotate slowly and the variation in magnification is large when the rotation speed is increased. For example, the jog dial is made to rotate slowly so as to vary the magnification slowly with a low magnification, and the jog dial is made to rotate rapidly so as to vary the magnification rapidly with a high magnification. At the time of lowering the magnification, it is possible to rapidly lower the magnification from a high magnification to a low magnification. The magnification may be roughly adjusted by making the jog dial 91 rotate rapidly and then the magnification may be accurately adjusted by making the jog dial 91 rotate slowly. When registering a recipe, the computer 41 may store the recipe as an inspector operates the jog dial 91.

A plurality of function change switches 92 are provided in the jog dial 91. By selecting a function change switch 92, it is possible to switches the items of the inspection condition. For example, by pushing the function change switch 92 assigned to a zoom function and then making the jog dial 91 rotate, it is possible to adjust the inspection condition of the zoom. By pushing the function change switch 92 assigned to a rotation speed and then making the jog dial 91 rotate, it is possible to adjust the inspection condition of the rotation speed. It is preferable that the function change switches 92 are disposed in the same number of the number of items of the inspection condition. However, the setting items of the inspection condition may be switched sequentially one by one every time when one function change switch 92 is pressed. Accordingly, it is possible to accomplish the saving of space. In addition, when the jog dials 91 are provided in the same number as the items, the function change switches 92 are not necessary.

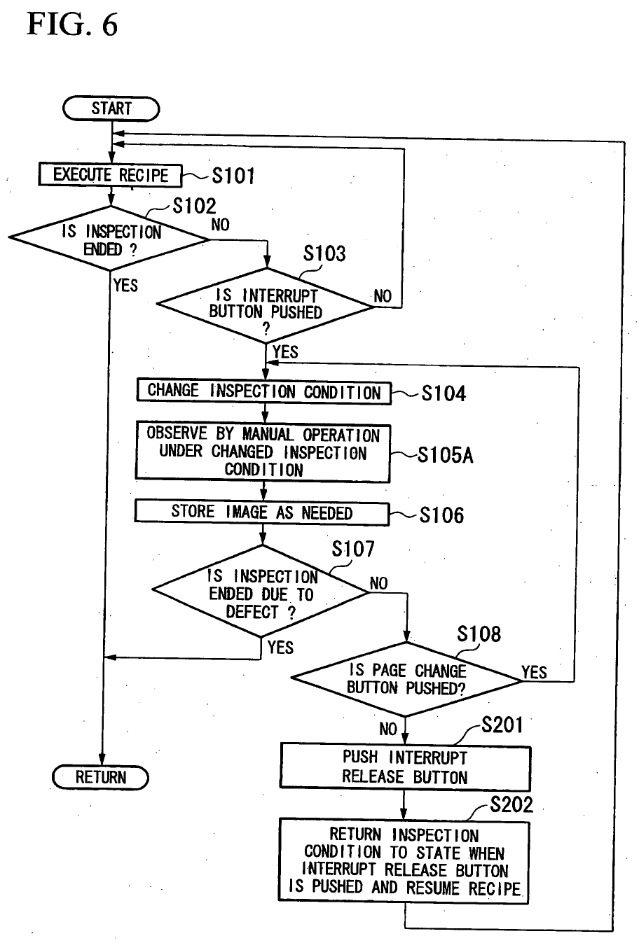

As shown in the flowchart of FIG. 6, the interrupt process is substantially equal to that of the first embodiment in steps S101 to S108. That is, when the interrupt button 82 is pressed in step S103 in the course of performing a recipe, the recipe is discontinued and the information at the time of discontinuance the recipe is stored. When the inspection condition is changed (step S104), the observation is by with a manual operation under the changed inspection condition (step S105A). The jog dial 91 is used in the manual operation, but the scroll bars 71 to 74 displayed on the monitor 44 may be used. When a rotation speed is assigned to the jog dial 91, the suction stage 16 rotates reversely by making the jog dial 91 rotate reversely.

When an inspection using manual operation is not necessary, the interrupt release button 83 is pressed (step S201). By pushing the interrupt release button 83, the flow is returned to the state when the interrupt button 82 is pressed (step S202).

In this embodiment, it is possible to obtain the same advantages as the first embodiment by enabling the interrupt process. Since a new recipe is registered due to the change in condition, it is possible to make an inspection using the new recipe.

The invention is not limited to the above-mentioned embodiment, but is widely applicable.

For example, the jog dial 91 may be provided in the visual inspection apparatus shown in FIG. 1. The visual inspection apparatus shown in FIG. 5 may not include the jog dial 91. A joystick and soon may be used instead of the jog dial 91.

The wafer holder 4 is not limited to the configurations of the above-mentioned embodiments, as long as it can move a wafer W in three directions (X, Y, and Z) and rotate the wafer W. Instead of moving the wafer W in the X, Y, and Z directions, the peripheral edge imaging section 5 may be mounted on the X stage, the Y stage, and the Z stage so as to move in three directions (X, Y, and Z). A mechanism movable in at least one of the X Y, and Z directions may be provided in the wafer holder 4 and mechanisms movable in the other two directions may be provided in the peripheral edge imaging section 5.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A visual inspection apparatus comprising:
a wafer holder that holds a wafer so as to be rotatable;
a peripheral edge imaging section that acquires an enlarged image of a peripheral edge of the wafer,
an interrupt processor that stops a visual inspection of the wafer pursuant to a predetermined recipe and performs an interrupt process, in the course of making the visual inspection pursuant to the recipe;
an inspection condition setting section that allow a change in inspection condition to be input every inspection condition item as the interrupt process so as to conduct an inspection under an inspection condition different from the predetermined recipe; and
an input unit used to allow an inspector to input the inspection condition to the inspection condition setting section.

2. The visual inspection apparatus according to claim 1, wherein the interrupt processor resumes the inspection pursuant to the predetermined recipe at the place where the inspection is stopped, after performing an inspection under the inspection condition different from the predetermined recipe.

3. The visual inspection apparatus according to claim 1, further comprising a recipe register that registers the inspection condition as a new recipe after the interrupt processor performs an inspection under the inspection condition different from the predetermined recipe.

4. The visual inspection apparatus according to claim 1, wherein the visual inspection pursuant to the recipe is to observe a plurality of places or a plurality of areas with a predetermined interval in the peripheral direction.

5. The visual inspection apparatus according to claim 1, further comprising an image processor that processes an image from the peripheral edge imaging section,
wherein the image processor calculates a difference of brightness between a reference image input in advance and an image captured at the peripheral edge imaging section, and the difference of brightness considers and an area in which a predetermined threshold value is exceeded as a defect.

6. The visual inspection apparatus according to claim 1, further comprising an image processor that detects brightness from an image acquired by the peripheral edge imaging section,
wherein the interrupt process is automatically performed when the brightness is greater than a predetermined threshold value.

7. The visual inspection apparatus according to claim 1, wherein at the time of performing the interrupt process, the interrupt processor controls the wafer holder to rotate at a speed equal to or less than a predetermined speed until the interrupt process is released.

8. The visual inspection apparatus according to claim 1, wherein the interrupt processor stores in advance a rotation speed corresponding to a magnification of the peripheral edge imaging section and controls the rotation speed of the wafer holder in accordance with the magnification changed at the time of performing the interrupt process.

9. The visual inspection apparatus according to claim 1, wherein the inspection condition setting section includes a scroll bar provided at every changeable item of the inspection condition and a mark indicating a condition value set by the scroll bar.

10. An visual inspection method of making a visual inspection of a peripheral edge of a wafer by observing an enlarged image of the peripheral edge while rotating the wafer pursuant to a predetermined recipe, the visual inspection method comprising:
stopping the inspection pursuant to the predetermined recipe in response to an insector's instruction in the course of making a visual inspection of the peripheral edge of the wafer pursuant to the predetermined recipe;
performing an inspection under a different inspection condition changed by the inspector; and
resuming the inspection pursuant to the predetermined recipe after finishing the inspection under the different inspection condition.
